(19) United States
(12) Patent Application Publication
(10) Pub. No.: US 2003/0021885 A1
(43) Pub. Date: Jan. 30, 2003

(54) Processing line having means to monitor crystallographic orientation

(76) Inventors: Shara S Shoup, Woodstock, GA (US); Andrew T Hunt, Atlanta, GA (US)

Correspondence Address: ALFRED H. MURATORI, MICROCOATING TECHNOLOGIES, INC., 5315 PEACHTREE INDUSTRIAL BLVD, ATLANTA, GA, 30341-2107, US

(21) Appl. No.: 10/111,696

(22) PCT Filed: Feb. 7, 2001
(86) PCT No.: PCT/US01/03948

(51) Int. Cl. B05D 1/36; B05D 3/00

(52) U.S. Cl. 427/8; 427/402; 427/331

(57) ABSTRACT

Apparatus for continuously moving a substrate and coating the substrate with a crystalline coating has at least one means for monitoring the crystalline orientation of the coating, either continuously or periodically.

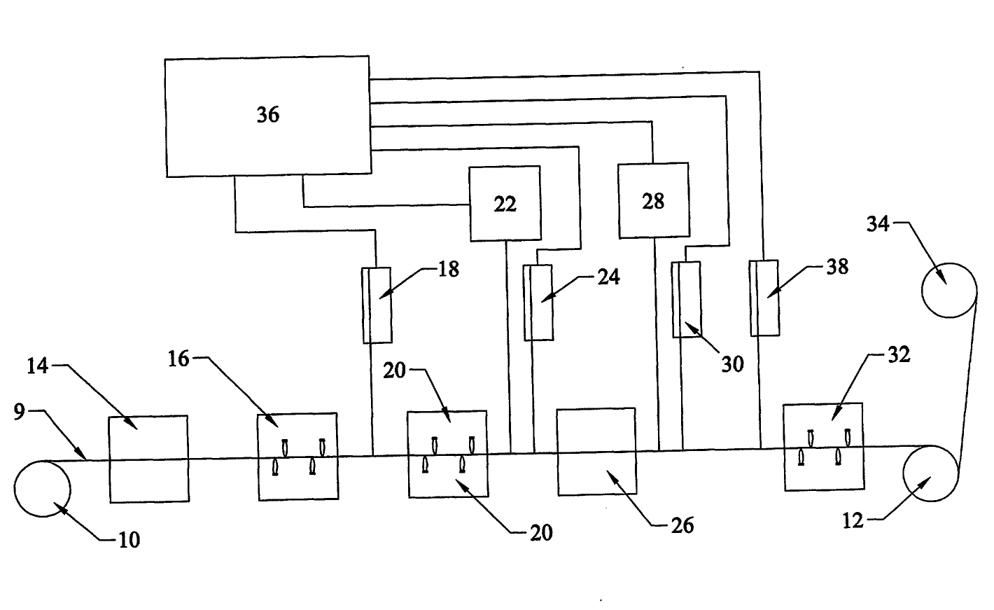

### FIELD OF THE INVENTION

The present invention is directed to a processing line for producing crystalline materials including means to monitor the crystallographic orientation of one or more of the crystalline materials that are produced.

### BACKGROUND OF THE INVENTION

U.S. Pat. No. 5,652,021 describes a flame deposition technique termed combustion chemical vapor deposition or “CCVD”. U.S. Pat. No. 5,997,956 describes a CCVD process using near supercritical fluid solutions. U.S. patent application Ser. No. 09/067,975 describes apparatus and process for “Controlled Atmosphere Chemical Vapor Deposition” or “CACCVD”. The teachings of each of the above-mentioned U.S. Patents and Applications is incorporated herein by reference. The techniques taught in these patents and applications allow for large-scale, open atmosphere, deposition of a variety of materials.

Among materials which may be deposited by CCVD or CACCVD are superconducting materials such as yttrium/barium/copper oxides. The electrical performance of the superconducting material is closely related to the crystallographic orientation of the superconducting material. Because of the scale-up capabilities of the CCVD and CACCVD processes, superconducting materials may be deposited as thin films on a continuously moving substrate web, such as a web of metal foil, e.g., nickel or nickel alloy foil. Because of the sensitivity of superconducting properties of a thin film material to crystallographic orientation, it is desirable to monitor the crystallographic orientation of the superconducting material as deposited on the continuously moving web. Also, it is desirable to measure crystallographic orientation of the web of foil and any buffer layer which is deposited prior to deposition of the superconducting thin film. If improper deposition (i.e., incorrect crystallographic orientation) takes place, this improper deposition may be recorded, e.g., by computer, and defective sections of the coated web noted for non-use. In-line monitoring also allows the processing conditions to be changed to correct the deposition when defective sections are found.

While an immediate application of apparatus in accordance with the invention is for production and inspection of superconducting thin films, the invention is applicable to production of and inspection of layers of crystallographic material on a continuously moving substrate, especially those where crystallographic orientation is desired.

### SUMMARY OF THE INVENTION

The present invention is directed to a processing line for producing a layer of material exhibiting a preferred crystallographic orientation on a moving substrate. The processing line includes means for continuously or periodically monitoring the crystallographic orientation of the material being produced

### IN THE DRAWING

The FIGURE is a diagram of apparatus in accordance with the Invention.

### DETAILED DESCRIPTION OF CERTAIN PREFERRED EMBODIMENTS

The invention is described hereinbelow in reference to a particular apparatus currently preferred by the inventors for producing a thin film of superconducting material on a continuously moving web. However, it is to be understood that the invention is applicable to a variety of processes for producing a crystallographically oriented material on a moving substrate and continuously or periodically monitoring this crystallographic orientation. Processing lines for producing a variety of crystallographically oriented materials will be designed in accordance with the exigencies of the particular processes.

The processing line of the present invention is particularly adapted to producing a superconducting wire having a metal wire substrate, an oxide buffer layer, and a superconducting layer. The wire may be a rolling-assisted, biaxially-textured metal substrate having a surface that provides a template for epitaxial growth. An epitaxial oxide buffer layer is deposited thereontop. Then a superconducting layer having an epitaxial crystallographic structure. Alternatively, the substrate may be a non-textured metal that has been coated with a textured coating, such as may be produced by ion beam assisted deposition.

In the illustrated apparatus, a moving web 9 of material, e.g., nickel foil, is fed out from a pay-out spool 10, the foil is coated, and the processed foil is taken up on a take-up spool 12. The foil 9 in the illustrated apparatus is first subjected to a rolling mill 14 which presses the foil into the desired thickness gauge.

The foil 9, appropriately gauged, is then subjected to a flame annealing set-up 16 which adjusts the crystalline structure of the foil. The rolling mill 14 and the annealing set-up 16 are optional, provided that the foil is appropriately rolled and heat-treated prior to the coating process. These steps are desirable in that alignment of the crystalline orientation of the foil helps to determine the crystalline orientation of layers to be deposited thereon. Downstream of the annealing set-up 16 is a first means 18, in the form of an X-ray diffraction monitor, for monitoring the crystalline orientation of the foil 9. The X-ray diffraction monitor preferably employed is an area detector which is most appropriate for monitoring crystalline structure of the material passing in view of the detector. At this time, a buffer layer(s) is deposited on the moving web of metal foil 9 in a first deposition set-up 20. Appropriate buffer layers include, but are not limited to SrTiO₃, CeO₂, yttrium-stabilized zirconium, and LaAlO₃. The buffer layer acts to prevent metal diffusion from the foil 9 to the superconducting layer which is to be subsequently deposited thereon and thereby protect the superconducting layer from changes in its chemical and structural make-up. The barrier layer also protects the foil against oxidation. The thickness of the buffer layer is measured by an optical thickness monitor 22. Typically, the buffer layer is between about 50 and 1000 nanometers.

A second means 24 for monitoring crystalline structure, i.e., another area detector X-ray diffraction unit, is located downstream of the thickness monitor 22 for measuring the crystalline orientation of the buffer layer. Again, the crystalline orientation of the buffer layer is a factor in determining the crystalline orientation of the superconducting material layer which is to be deposited thereon.

Next, the superconducting layer is deposited at superconductor deposition set-up 26. The superconducting layer is deposited either by a CCVD or CACCVD process, or the superconducting layer may be deposited by a sol-gel process. Typically, the superconducting layer is between about 200 nm and about 5 microns thick. Thickness is measured by monitor 28. Regardless of the method of deposition, the crystalline structure of the superconducting layer is monitored by a third means 30 for monitoring crystalline structure. Again, this apparatus 30 is preferably an area detector X-ray diffraction apparatus.

Downstream of the monitor 30, the superconductor layer is coated with a protective layer of material at a passivation layer deposition set-up 32. The passivation layer may be materials such as Ag, CeO₂ and SrTiO₃ and are typically deposited to a thickness of between about 50 and 1000 nanometers thick. Deposition of the passivation layer may be by CCVD, CACCVD, or other suitable deposition layer known in the art.

As the finished product is reeled on spool 12 it is layered with a separator slip sheet from spool 34 to protect the finished product from abrasion and other mechanical damage. The slip sheet is typically a polymeric material, such as poly(tetrafluoroethylene) (Teflon®) which protects the product but which is easily removed therefrom.

Each of the X-ray diffraction units 18, 24, and 30, as well as the in-line thickness monitors 22 and 28 are preferably linked to a computer 36 which receives the monitoring data from the several detectors and determines whether depositions are proceeding properly. If deposition is improper at any stage, feedback mechanisms are built in to adjust deposition parameters at the several processing stations 16, 20, and 26. Also, the computer 36 will record lengths of mis-coating on the web so that mis-coated sections can be subsequently discarded.

Shown downstream of the last X-ray diffraction monitor 30 is an X-ray fluorescence (XRF) apparatus for monitoring the chemical composition of the superconducting layer. Similar X-ray fluorescence monitors could be used to monitor any of the other deposited layers. The XRF monitor is likewise connected to the computer 36 for providing feedback to processing station 26.

What is claimed is:

1. A processing line comprising:
means for continuously conveying a substrate having at least one surface,
at least one processing station for processing said one surface to impart a desired crystallographic structure on said one surface,
means for determining the crystallographic structure of said one surface downstream of said one processing station, and
feedback means for adjusting conditions at said processing station according to the determined crystallographic structure of said one surface.

2. The processing line according to claim 1 wherein said determining means is an X-ray diffraction monitor.

3. The processing line according to claim 1 wherein said one surface is a metal surface.

4. The processing line according to claim 1 wherein said one surface is an oxide layer.

5. The processing line according to claim 1 wherein said one surface is a superconducting layer.

6. The processing line according to claim 1 wherein said desired crystallographic structure is epitaxial.

7. The processing line according to claim 1 further comprising a second processing station for forming on said one surface a first layer of material having a desired crystallographic structure, second means for determining the crystallographic structure of said layer downstream of said second processing station, and second feedback means for adjusting conditions at said second processing station.

8. The processing line according to claim 7 further comprising a third processing station for forming on said first formed layer a second layer of material having a desired crystallographic structure, third means for determining the crystallographic structure of said second layer downstream of third processing station, and third feedback means for adjusting conditions at said second processing station.

9. The processing line according to claim 8 wherein said one surface is metal, said first layer is a buffer layer, and said second layer is a superconducting layer.

10. The processing line according to claim 1 further comprising means for determining the chemical composition of the material that provides said one surface.

11. The processing line according to claim 10 wherein said means for determining the chemical composition comprises an X-ray fluorescence apparatus.

12. The processing line according to claim 1 wherein said processing line further comprises one or more processing stations for forming on said one surface one or more layers of compositions and said processing line further comprises means for determining the chemical composition of at least one layer.

13. The processing line according to claim 10 wherein said means for determining the chemical composition comprises an X-ray fluorescence monitor.
